(19) United States
(12) Patent Application Publication
(10) Pub. No.: US 2013/0035107 A1
(43) Pub. Date: Feb. 7, 2013

(54) SYSTEM AND METHOD FOR ADAPTIVE TRAFFIC PRIORITIZATION AND BANDWIDTH ALLOCATION ON MOBILE DATA NETWORKS

(71) Applicants: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(72) Inventors: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(73) Assignee: XTREME LABS INC., Toronto (CA)

(21) Appl. No.: 13/562,743

(22) Filed: Jul. 31, 2012

Related U.S. Application Data
(60) Provisional application No. 61/513,829, filed on Aug. 1, 2011.

(51) Int. Cl. H04W 72/10

(52) U.S. Cl. 455/453

(57) ABSTRACT

A method is provided for adaptively acquiring bandwidth on a mobile device given traffic prioritization and bandwidth allocation rules of an infrastructure service provider. The device submits to the service provider a first bandwidth query, which includes a first content type and a first bandwidth requirement estimate. The device retrieves from the service provider information as to its traffic prioritization and bandwidth allocation rules and limitations relevant to the first query. This information is made available to the application on the device that needs the bandwidth. The application responds, and the device then sends a second bandwidth query to the service provider which includes a (possibly modified) bandwidth request. Provided this request is valid, bandwidth is obtained for the application on the device according to the request. In a variation, speed test data is used in lieu of or in addition to information from the service provider.

### CROSS REFERENCE TO RELATED APPLICATION

This application claims priority from U.S. Provisional Application No. 61/513,829 filed on Aug. 1, 2011, which is incorporated by reference in its entirety herein.

### TECHNICAL FIELD

The invention is directed to methods and systems for prioritizing and allocating bandwidth in a mobile network, and for devices to respond to provider rules about prioritizing and allocating bandwidth.

### BACKGROUND

As with any other communication medium, mobile data networks continue to evolve, achieving increasingly faster speeds. In practice, however, although maximum theoretical throughput climbs, the total bandwidth is divided across an ever-increasing number of connected devices, often leading to an overall net loss in terms of overall performance. With bandwidth-intensive activities such as video streaming and teleconferencing gaining popularity, available bandwidth may be allocated arbitrarily, often yielding an inconsistent end-user experience.

Various quality of service systems exist, control mechanisms which can reserve, prioritize and allocate resources based on any specific set of arbitrary criteria. These mechanisms can include traffic shaping, scheduling algorithms, congestion avoidance and other techniques, each offering its own unique advantages, disadvantages and overall effects on bandwidth. But while quality of service can yield certain performance gains, some of its major limitations stem from its lack of interaction with end-point devices.

Specifically, with current quality of service systems, it is impossible for applications running on connected mobile devices to accurately detect what portion of available bandwidth is being allocated to them, whether this bandwidth is being treated or otherwise manipulated, and whether the throughput will remain consistent throughout the duration of the operation in question. This unfortunate restriction makes it nearly impossible for all but the most advanced application algorithms to properly cope with varying differences in throughput, which creates interruptions which are often visible and disruptive to the end-user. For example, users attempting to stream video on congested networks will often see pauses as the application repopulates the buffer.

It would be desirable to address or improve some of these problems by improving communication between devices and infrastructure service providers.

### SUMMARY

By promoting transparency of the service provider restrictions and requirements, it is believed that this would allow devices and their applications to better tailor requests and thus benefit from an increased probability of valid and fulfillable bandwidth requests.

This would also reduce performance issues by only allowing valid and pre-screened requests that take into account bandwidth availability forecasts. It is a goal to use devices to provide signals to distribute traffic better, so it's possible to ask for the right thing based on traffic conditions.

Devices can also provide feedback to help service provider manage traffic (by supplying localized data from the devices). Although the invention is fundamentally device-centric, the impact is at a network-level. The idea is to expand this data set to the whole network, based on the collected data from many devices that are providing feedback into the network. Further, this will allow developers to build a better app ecosystem and a better network by providing hooks at a network level, and getting everyone else to adopt these beneficial standards.

According to a first aspect of the invention, a method is provided for adaptively acquiring bandwidth on a mobile device given traffic prioritization and bandwidth allocation rules of an infrastructure service provider. The device submits a first bandwidth query to the service provider, including a first content type and a first bandwidth requirement estimate. Information is retrieved from the service provider as to its traffic prioritization and bandwidth allocation rules and limitations relevant to the first query. This information is then made available to an application on the device, which provides a response. In light of the response, a second bandwidth query is submitted to the service provider, including a request for bandwidth based on the information. Provided this second bandwidth query is valid, bandwidth is obtained for the application on the device according to the request.

The device may further provide congestion, latency or other localized condition data to the service provider. This data may, for example, be provided in the course of the first bandwidth query or the second bandwidth query. The location of the device may also be specified to assist the service provider in mapping local conditions with feedback from many devices.

The device may further run a speed test as to the connection speed. The speed test data can then be returned to the service provider. The speed test may be run following the first bandwidth query. Alternatively, or in addition, the speed test may be run and reported to the service provider at intervals, irrespective of the first and second bandwidth queries.

The second bandwidth query may include a second content type, downgraded from the first content type, in response to the information from the service provider. The second bandwidth query may also (or in addition) include a second bandwidth requirement estimate, downgraded from the first bandwidth requirement estimate, in response to the information from the service provider. For example, the second bandwidth query may include a modified content type or bandwidth requirement estimate if the information from the service provider suggests that the connection or performance would be poor.

The second bandwidth query may be formulated to express the request according to rules of the service provider. For example, the second bandwidth query can be formulated to express the request for first-come-first-served bandwidth if accepted by the service provider according to the information. Alternatively, the second bandwidth query may be formulated to express the request for type-specific bandwidth if within a proportion accepted by the service provider according to the information.

Input from the user may be sought prior to submitting the second bandwidth query.

According to a second aspect of the invention, a method is provided for adaptively acquiring bandwidth on a mobile device given traffic prioritization and bandwidth allocation rules of an infrastructure service provider. The device runs at least one speed test to evaluate bandwidth available for a prospective bandwidth use by an application on the device and generates speed test data. Based on the device application response to that speed test data, a bandwidth query is submitted to an infrastructure service provider, including a request for bandwidth. The speed test data and location of the device are also submitted to the service provider. Provided the query is valid according to traffic prioritization and bandwidth allocation rules of the service provider, bandwidth is obtained for the application on the device according to the request.

### BRIEF DESCRIPTION OF THE DRAWINGS

FIG. 1 is a visual representation of the interactive quality of service system in a cellular coverage area.

FIG. 2 is a flow diagram illustrating the process to determine traffic prioritization and bandwidth allocation.

### DETAILED DESCRIPTION

This system defines an interactive quality of service method, in which the infrastructure providing and managing the available bandwidth does not run completely independently of connected devices. This contrasts with traditional methods where devices would request bandwidth blindly since service provider restrictions were generally only detectable after the fact. In the present case, service providers can passively or actively communicate with these clients, providing details as to what sort of line quality and consistency can be expected for a given time segment, and receiving feedback from client devices as well.

For example, such feedback may include latency and throughput, location and cell tower data, etc. These may be calculated by the device and sent as sample data sets.

Thus the network may find that there is only congestion in a certain area (e.g. downtown) while the rest of the network is steady, so it may start rerouting some of the downtown traffic to ease the congestion.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

It should also be noted that the invention is not limited to any particular software language described or implied in the figures and that a variety of alternative software languages may be used for implementation of the invention.

Many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks in which computer code may also be generated are Ruby on Rails which is based on the Ruby programming language, or node.js which is an event-driven server-side JavaScript environment.

The program code may execute entirely on the client device, partly on the client device, as a stand-alone software package, partly on the client device and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the Internet. The storage media can be inserted to the console where it is read. The console can then read program instructions stored on the storage media and present a user interface to the user.

In some embodiments, the device is portable. In some embodiments, the device has a display with a graphical user interface (GUI), one or more processors, memory and one or more modules, programs or sets of instructions stored in the memory for performing multiple functions.

It should be understood that although the term application has been used as an example in this disclosure in essence the term may also apply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

The computer program comprises: a computer usable medium having computer usable program code, the computer usable program code comprises: computer usable program code for presenting graphically to the users options for scrolling via the touch-screen interface.

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention.

The device may include but is not limited to a personal computer (PC), which may include but not limited to a home PC, corporate PC, a Server, a laptop, a Netbook, a Mac, a cellular phone, a Smartphone, a PDA, an iPhone, an iPad, an iPod, an iPad, a PVR, a set-top box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where it exists already or is generated as a result. Client devices and server devices (or systems) may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

The present invention makes use of multiple queries or handshakes to define a fulfillable bandwidth request. Bandwidth availability is forecasted in light of these queries. The mobile device's operating system can then share this data with a running application as it sees fit. Practically, this will allow end-user applications to internally adjust their settings in order to accommodate the expected line conditions, ensuring a smoother and consistent user experience. For example, a video streaming application which receives an unfavorable prognosis for bandwidth will be able to compensate by lowering the bitrate or resolution to better accommodate the available throughput.

Developers are given access to check the network conditions to preemptively select the appropriate type of feed or data access (i.e. don't access high resolution streams when the traffic is too heavy). This type of access and gatekeeping can also help enforce and track usage in a more fine-grained way given that there is a handshake process for both finding out the current network conditions and accessing the network.

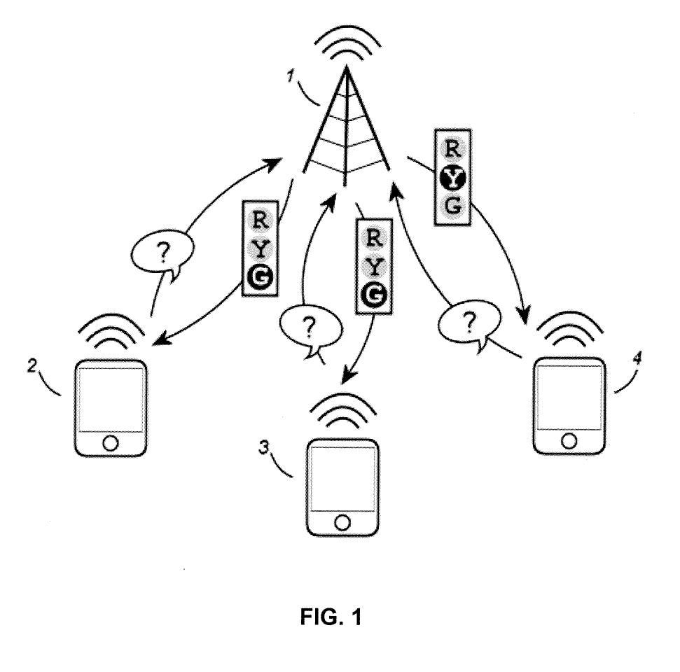

Referring to FIG. 1, a hypothetical scenario is depicted in which a number of mobile devices 2,3,4 are connected to an infrastructure component 1 providing bandwidth.

Devices constantly receive feedback from the infrastructure component at regular, configurable intervals or key events. Key events may include starting an application on the client device that requires bandwidth usage.

Again referring to FIG. 1, the following sample scenario is provided. The first device 2 queries the infrastructure component 1 (i.e. service provider or related entity), which indicates that sufficient bandwidth is available for the type of application(s) it is running.

This device 2 subsequently proceeds with its operation normally. A second device 3 queries the infrastructure component 1, which once again indicates that sufficient bandwidth is available for application(s) it is running. This device 3 subsequently proceeds with its operation normally. A third device 4 queries the infrastructure component 1. However, the infrastructure component 1 is now in a congested state due to the demands of the connected devices 2,3, and indicates that only limited bandwidth is available. This device 4 adjusts its settings to accommodate this reduced throughput and proceeds with its operation. During subsequent queries, device 4 receives indication from infrastructure component 1 that additional bandwidth is now available.

The device 4 now adjusts its bandwidth consuming applications to use the optimal maximum available.

In the absence of any other demands, available bandwidth is allocated on a first come, first serve basis. As the network becomes more congested, heuristics are applied that distribute bandwidth according to configurable criteria which may include: prioritization of certain user accounts, such as for public emergency services; the degree to which first come, first serve is applied, as opposed to the absolute equalization of bandwidth; and the bandwidth permitted for any given content or MIME-type. Information is made available to the infrastructure component 1 through queries, including but not limited to, bandwidth capacity and signal quality, such as in −dBm units, from the perspective of any given connected device. Conditions are preferably signalled to the device through the network level. The OS is preferably able to modify any network requests to have a priority that the network can process.

In an embodiment, queries from devices to the infrastructure consist of Internet content-type or MIME type (such as video, music, images, text) and each such query includes an estimate of the bandwidth requirement expressed as both minimum and optimal. The infrastructure determines the most even bandwidth distribution based on the needs of all users currently connected. It also factors in the signal quality, adjusting the bandwidth by providing a higher amount to those that could make better use of it, or lowering the amount for poor signal quality. In the latter, for example, a request for video bandwidth from a device with poor signal quality would be allocated the minimum bandwidth required for any given video content type. Such heuristics ensure the most appropriate distribution of bandwidth given any particular set of configurable criteria.

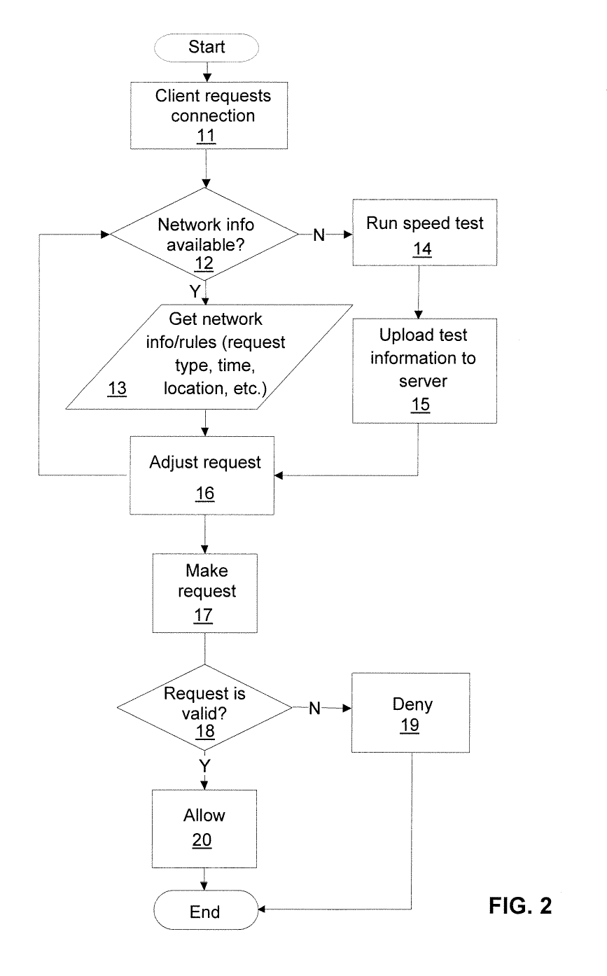

The process flow of one embodiment is depicted in FIG. 2. A client device makes a request to the infrastructure component 11 (e.g. the infrastructure mobile/cellular bandwidth provider). The client device queries the provider 12 as to what bandwidth and latency is available. This is the first handshake between client and provider. If this information is available, numerous parameters are returned 13. These are configurable and may include: available data speed rates; rules relating to the set of applications and request types which can access the bandwidth and in what proportions; the date, time and current location, such as from an embedded GPS device or extrapolated from the cellular data; and so forth. Application and request types are such things as video streaming or other bandwidth intensive or latency sensitive activities. The provider's rules pertaining to bandwidth usage are dynamic and constantly updated. If no such information is available, the client device and/or provider's server perform a download/upload (bandwidth) and latency speed test 14. This is an important component of one embodiment of the present invention, since the speed test allows collection of information relevant to bandwidth allocation even when the provider does not have such information beforehand. The results of such a test are recorded on the provider's database 15 for future references by other devices in the same coverage area, such that they can proceed directly to stage 13. From time to time at a configurable interval, the speed test is repeated with other client devices in order to constantly keep the bandwidth and latency information—and therefore the provider's rules—current. The client device receives information from the provider 16 to internally adjust bandwidth requests depending on the application running. For example, in bandwidth intensive applications such as video streaming, the application on the client device adjusts its bit rate according to the information from the provider. Similarly, latency dependent applications may also need to adjust their internal settings accordingly. Rules pertaining to such applications at that particular date and time are subject to constant updates. From time to time at a configurable interval, the client device polls the provider for the latest network information in order to constantly adjust bandwidth usage to optimal levels and account for latency. Applications on the client device make requests for service at specific parameters 17 in compliance with available bandwidth and rules. This is the second handshake between client and provider. The provider evaluates whether requests with desired parameters are valid 18, as providers and clients may each employ differing interpretations as to which of any specific parameters are prioritized, such as latency. If it is not, then the request is denied or bandwidth is throttled 19. This is another alternative embodiment of the present invention in that the request for bandwidth may be denied where the desired parameters cannot be fulfilled. In other words, rather than provide a user with a degraded or poorly functioning experience the users' request is denied. If the request and parameters meet the network's information and rules as disclosed in stage 13, the request is allowed 20 and the process is permitted to continue at the current date and time.

For example, when a user initiates a video call, the network conditions are checked in the first handshake and if the network is busy the video call can be replaced by a voice call. In another example, the user may request an high definition (HD) version of a video on YouTube, but since the network is busy, the standard definition (SD) version is served instead.

This could also give network operators the ability to disable video-streaming and audio-streaming services when a network is under heavy usage (so all other types of transfers can go through). For example in case of an emergency (earthquake, tsunami, war), non-essential items (e.g. video streaming from YouTube) can be disabled so that voice call and emergency text messages can be given more priority and more bandwidth.

The intent of the application is to cover all such combinations and permutations not listed here but that are obvious to the ones skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

1. A method of adaptively acquiring bandwidth on a mobile device given traffic prioritization and bandwidth allocation rules of an infrastructure service provider, comprising:
submitting a first bandwidth query to the service provider, including a first content type and a first bandwidth requirement estimate;
retrieving from the service provider information as to its traffic prioritization and bandwidth allocation rules and limitations relevant to the first query;
making available the information to an application on the device, and receiving a response from the application;
in light of the response, submitting a second bandwidth query to the service provider, including a request for bandwidth based on the information; and
provided the second bandwidth query is valid, obtaining bandwidth for the application on the device according to the request.

2. The method of claim 1, further comprising the device providing congestion, latency or other localized condition data to the service provider.

3. The method of claim 2, wherein the congestion, latency or other localized condition data is provided in the course of the first bandwidth query or the second bandwidth query.

4. The method of claim 2, wherein the congestion, latency or other localized condition data is provided with data specifying the location of the device.

5. The method of claim 1, further comprising the device running a speed test as to the connection speed, and returning speed test data to the service provider.

6. The method of claim 5, wherein the speed test is run following the first bandwidth query.

7. The method of claim 5, wherein the speed test is run and reported to the service provider at intervals, irrespective of the first and second bandwidth queries.

8. The method of claim 1, wherein the second bandwidth query includes a second content type, downgraded from the first content type, in response to the information from the service provider.

9. The method of claim 1, wherein the second bandwidth query includes a second bandwidth requirement estimate, downgraded from the first bandwidth requirement estimate, in response to the information from the service provider.

10. The method of claim 1, wherein the second bandwidth query includes a modified content type or bandwidth requirement estimate if the information from the service provider suggests that the connection or performance would be poor.

11. The method of claim 1, wherein the second bandwidth query is formulated to express the request according to rules of the service provider.

12. The method of claim 1, wherein the second bandwidth query is formulated to express the request for first-come-first-served bandwidth if accepted by the service provider according to the information.

13. The method of claim 1, wherein the second bandwidth query is formulated to express the request for type-specific bandwidth if within a proportion accepted by the service provider according to the information.

14. The method of claim 1, wherein input from the user is sought prior to submitting the second bandwidth query.

15. A method of adaptively acquiring bandwidth on a mobile device given traffic prioritization and bandwidth allocation rules of an infrastructure service provider, comprising:
running at least one speed test to evaluate bandwidth available for a prospective bandwidth use by an application on the device to generate speed test data;
based on the device application response to that speed test data, submitting a bandwidth query to an infrastructure service provider, including a request for bandwidth, and submitting to the service provider the speed test data and location of the device;
provided the query is valid according to traffic prioritization and bandwidth allocation rules of the service provider, obtaining bandwidth for the application on the device according to the request.
